(19) United States
(12) Patent Application Publication
(10) Pub. No.: US 2013/0111027 A1
(43) Pub. Date: May 2, 2013

(54) ACCESSING PHYSICAL RESOURCES IN A CLOUD COMPUTING ENVIRONMENT

(71) Applicants: Dejan S. MILOJICIC, Palo Alto, CA (US); Soumendu Bardhan, Jenks, OK (US); Richard Shaw Kaufmann, San Diego, CA (US); Vanish Talwar, Campbell, CA (US)

(72) Inventors: Dejan S. MILOJICIC, Palo Alto, CA (US); Soumendu Bardhan, Jenks, OK (US); Richard Shaw Kaufmann, San Diego, CA (US); Vanish Talwar, Campbell, CA (US)

(21) Appl. No.: 13/285,993

(22) Filed: Oct. 31, 2011

(51) Int. Cl. G06F 15/16

(52) U.S. Cl. 709/225

(57) ABSTRACT

In one implementation, physical resources are searched for in a cloud computing environment, access to the physical resources is acquired from a provider of the cloud, and the physical resources in the cloud are accessed.

### BACKGROUND

Cloud computing environments that offer computing resources (e.g., virtualized computational resources, virtualized storage resources, etc.) as a service to end users by implementing virtual resources on top of physical resources may hide the physical resources on which the virtual resources are implemented from end-users. Accordingly, end-users may not be allowed to access the actual physical machines on which the cloud is implemented.

### BRIEF DESCRIPTION OF THE DRAWINGS

FIGS. 1 and 2 illustrate example implementations of cloud computing environments.

FIGS. 3 and 4 illustrate example implementations of methods for controlling physical resources in a cloud computing environment.

The drawings referred to in this description should be understood as not being drawn to scale except if specifically noted.

### DETAILED DESCRIPTION

Reference will now be made in detail to implementations of the present technology, examples of which are illustrated in the accompanying drawings. While the technology will be described in conjunction with various implementation(s), it will be understood that they are not intended to limit the present technology to these implementations. On the contrary, the present technology is intended to cover alternatives, modifications and equivalents, which may be included within the spirit and scope of the various implementations as defined by the appended claims.

Furthermore, in the following description of implementations, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present implementations.

Cloud computing environments may provide computing resources (e.g., computation, storage, etc.) to end users as a service over a network connection (e.g., the Internet) such that the end users do not have to purchase the actual physical hardware (and potentially associated software) used to implement the computing resources. Individual cloud computing environments may be owned or operated by different entities, who, in some cases, may be referred to as cloud service providers. These cloud service providers then may offer the computing resources enabled by their cloud computing environments to end users who are unaffiliated with the cloud service providers. For example, in some cases, cloud service providers may offer the computing resources enabled by their cloud computing environments to customers in the general public in exchange for payments, which, for example, may be tied to the customers' actual usage of the cloud service providers' computing resources. Cloud computing may offer the perception of unlimited resources and elastic scaling, and it may offload the management of resources from clients to cloud management software acting behind the scene. This may be especially well suited to small business where upfront costs can be reduced by relying on cloud computing services provided by third parties and resources can be seamlessly scaled up and down on a pay per use model.

However, cloud computing environments provided by cloud service providers may hide the management of or provide limited exposure to resources, including those allocated to the user. As will be described in detail below, a cloud control point (CCP) concept may expose end users to more control of parts of the cloud such that the end users can have more opportunity to manage it the way their applications require it. Accordingly, users (e.g., Value Added Resellers (VARs)) can provide value add features to the existing cloud offering. Such features can include, but are not limited to, improved Quality of Service (QoS), guaranteed advanced reservation, search for specific resources in the partitions that CCP controls, allocation of topology-aware resources, increased business continuity, and federation of pieces of disparate clouds.

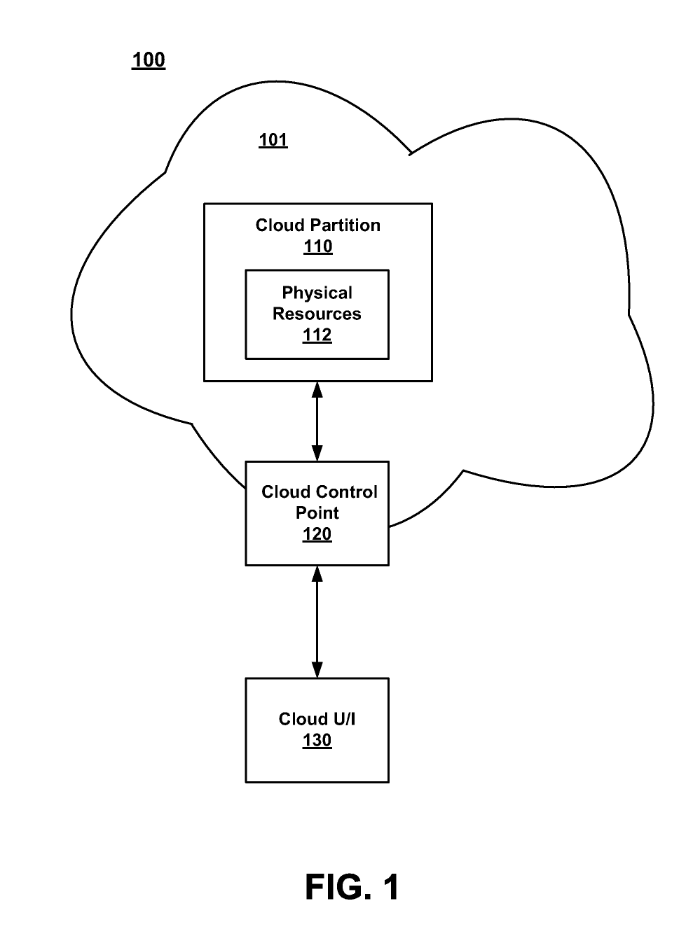

FIG. 1 depicts an implementation of a cloud computing environment 100. Cloud computing environment 100 includes cloud 101, cloud partition 110, physical resources 112, CCP 120, and cloud user interface 130.

Cloud 101 can be any system that provides computing as a service, whereby shared resources, software, and information are provided to computers and other devices as a utility over a network. In one implementation, cloud 101 is configured to enable virtual machines and virtual storage resources to be implemented on top of physical resources such that end users of cloud 101 are able to instantiate and use such virtual machines and storage resources. In one implementation, the computing service of cloud 101 is performed by physical resources in a data center.

Cloud partition 110 includes physical resources 112. In one implementation, physical resources 112 are a set of machines that include, but are not limited to, a topology mechanism (e.g., interconnect, networking, structure, etc.), resources (e.g., central processing units (CPUs), memory, disk, etc.), and colocation (e.g., same/different enclosure, rake, data center, geography, etc.). It should be appreciated that cloud 101 can include any number of cloud partitions with any combination of physical resources.

CCP 120, in combination with cloud user interface 130, allows a user, such as a VAR, who is not affiliated with the owner or operator of cloud 101 to reserve, acquire, and manage physical resources 112. In other words, CCP enables a user to “see through” the original cloud controller for a cloud instantiation and view/manage physical resources 112 on the resources provided as a service to end users are hosted, including enabling a user to reserve certain physical resources for a predetermined amount of time.

In particular, CCP 120 exposes internally owned physical resources (e.g., servers, server racks, CPUs, memory, etc.) to external entities (e.g., controllers, managers, performance sustainability systems, closed loop controls, node reservation systems, etc.) which effectively surrenders control and management of the part of the cloud. Moreover, CCP 120 allows for generating partitions in clouds with specific desirable properties (e.g., QoS, load distribution and resource management, federations, access rights, etc.) and then enforcing them as value added features to end-users. In one particular example, a VAR who has gained control of physical resources 112 in cloud 101 may exploit its ability to control the physical resources 112 to manage the physical resources 112 in a manner that enables the VAR to offer QoS-related agreements to end users that are more favorable to the end users than what the owner or operator of cloud 101 otherwise may be willing to offer the end users.

It should be appreciated that the VAR may offer the end users (e.g., its own users) access to cloud 101 through its own cloud user interface 130 and may rely on its own cloud controller to manage physical resources 112. Also, any original cloud controller provided by the cloud provider may be out of loop and without influence on VAR users.

In various implementations, reserving, acquiring and/or managing of physical resources can be accomplished by programmatic interfaces or a GUI tool via cloud user interface 130.

In one implementation, at the time of reservation, the VAR acquires access to physical machines from the original cloud provider through installation of certificates that enable access to the physical machines.

In another implementation, if the reservation time expires without freed up physical resources, the original cloud provider has an out of band management channel (e.g., integrated lights out (iLO)) to reacquire resources.

In one implementation, a user, such as a VAR, searches for desired physical resources in a partition. If the desired physical resources are available, then the VAR purchases the right to use physical resources in the partition for a temporary period of time. As a result, the VAR acquires the physical resources in the partition.

The physical resources can be acquired for various amounts of time. For example, a server with a desired topology can be reserved for two years by the VAR.

The VAR, subsequent to acquiring the physical resources, can install or implement various cloud management tools. Such tools, can include, but are not limited to, a cloud controller, Service Level Agreement management tools, support tools, etc.

In one implementation, the VAR can have a Service Level Agreement (SLA) with the provider of cloud 101. For example, if there is a failure of physical resources, the provider of cloud 101 can provide a replacement of the failed physical resources. In particular, if the SLA is not met, then the provider may be required to pay penalties to the VAR.

The VAR can resell use of the pool of physical resources to customers or end-users as value added features. Below is an example of the process of an end user obtaining control of the physical resources from the VAR.

First, it is determined if desired physical resources are available in cloud 101. If so, the end user makes a payment to the VAR for the desired partition. Accordingly, the desired physical resources are reserved for the end user. Whether or not the physical resources are used by the end user, the end user may cancel the reservation of the physical resources.

In one implementation, the end user may reserve the physical resources for a predetermined amount of time. For example, the end user may utilize a reservation system that enables the reservation of physical resources 112 from the VAR. In such an example, the end user may reserve the physical resources for any predetermined amount of time (e.g., two hours, three days, etc.).

In one implementation, the end user can have an SLA with the VAR. For example, if there is a failure of physical resources, the VAR can provide a replacement of the failed physical resources which improves the QoS. In particular, if the SLA is not met, then the VAR may be required to pay penalties to the end user.

As described above, the VAR can resell the pool of physical resources to customers or end-users as value added features. The value added features provided by the VAR to an end user can include the ability to:

1. Enable higher QoS through enforcement of cloud controllers.

2. Provide additional information and analytics. For example, load information through tools, such as Ganglia; sustainability of individual nodes/racks/sites through tools such as a cloud sustainability dashboard; and analytics about the resource usage (e.g., trends, comparison to average users, etc.).

3. Search for resources with more detail. For example, different configurations for high-performance computing (HPC), different ratios of computing power versus storage versus interconnect speeds to best match to the cloud service requirements that will be hosed on the cloud.

4. Improved support. For example, VARs can provide additional support in terms of failures of physical resources by allocating new physical resources from spares, or for improving performance in case there is performance degradation.

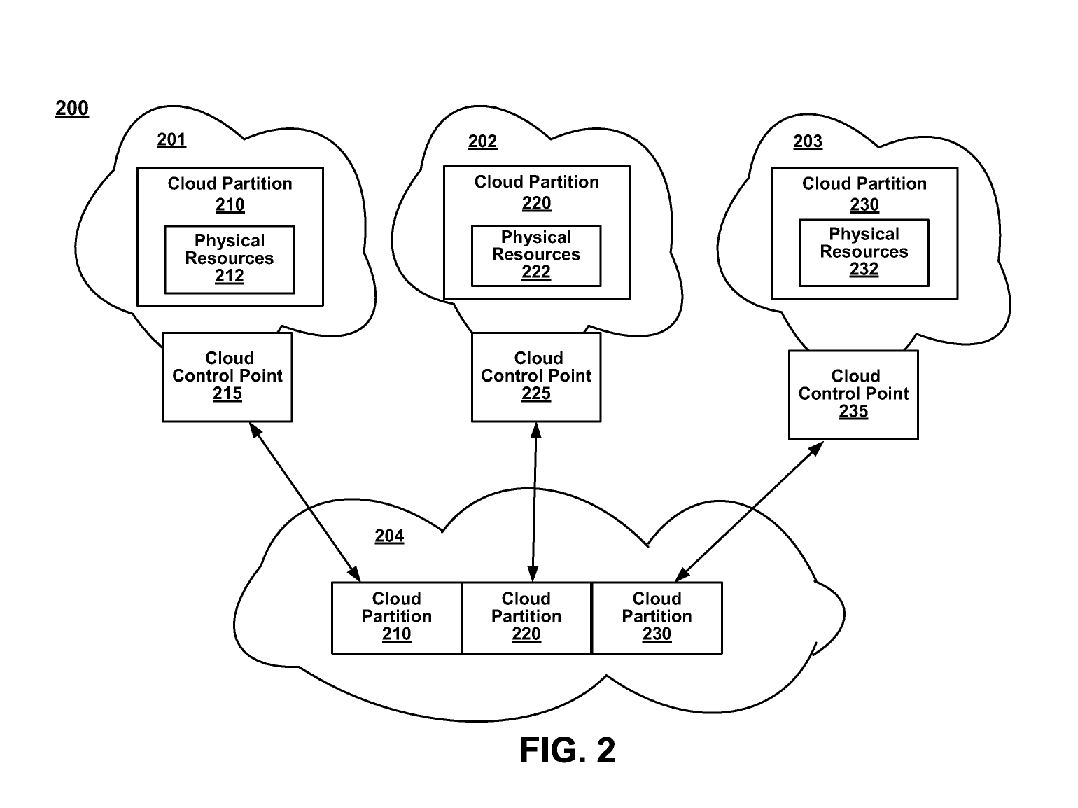

FIG. 2 depicts an implementation of cloud computing environment 200. Cloud computing environment 200 functions similarly to cloud computing environment 100, as described above. However, among other things, cloud computing environment 200 includes a plurality of clouds rather one cloud.

Cloud computing environment 200 includes clouds 201-203. Clouds 201-203 include cloud partitions 210, 220, and 230, respectively, and physical resources 212, 222, and 232, respectively. It should be appreciated that each of clouds 201-203 may function similarly as cloud 101, described above. Clouds 201-203 may function similarly to one another, however, they are discrete from one another and have different original providers. For example, each of clouds 201-203 may be owned and operated by different entities.

CCPs 215, 225 and 235 aggregate many physical resources. For example, CCPs 215, 225 and 235 aggregate physical resources 212, 222 and 232, respectively, to generate aggregated cloud 204. In other words, CCPs 215, 225 and 235 are utilized for cloud federation. By obtaining physical resources from various cloud providers, a VAR, who may be unaffiliated with the actual owners or operators of clouds 201-203, may accomplish a degree of cloud federation by means of aggregating information about all partitions from the different clouds 201-203. It should be appreciated that the federation/aggregation can be accomplished at the virtualized layer as well.

Accordingly, end users can access cloud partitions (and associated physical resources) via aggregated cloud 204 which is generated by the VAR, which itself may be unaffiliated with the owners or operators of clouds 201-203.

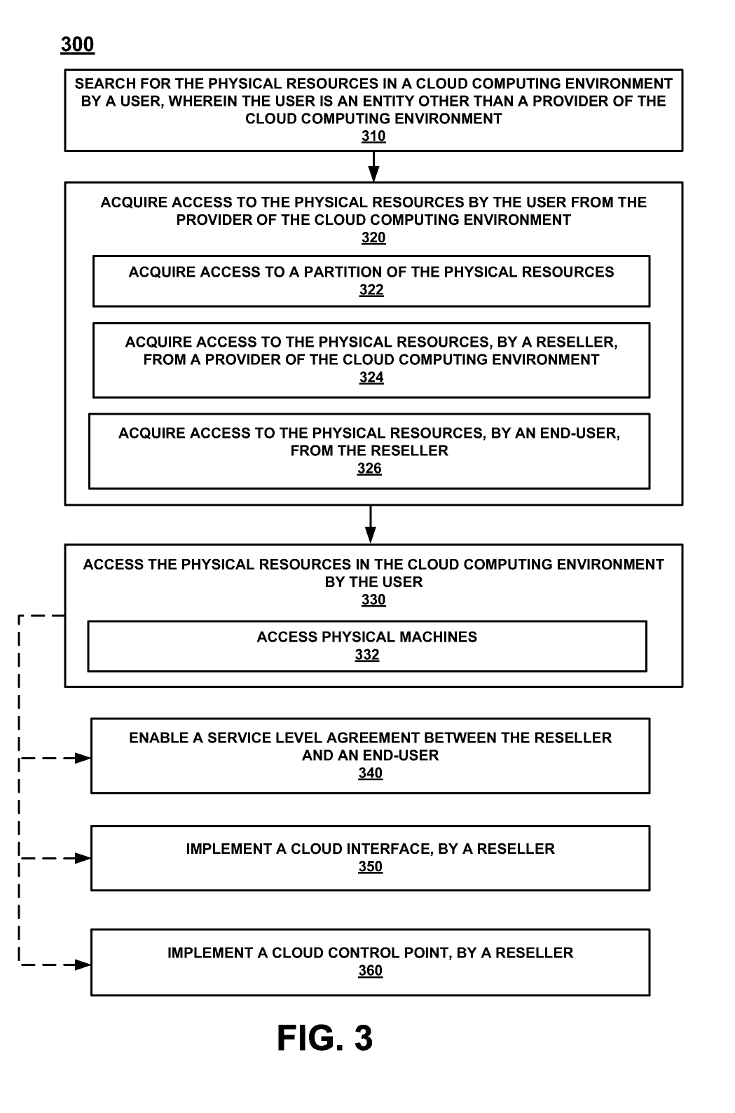

FIG. 3 depicts an implementation of a method 300 for accessing physical resources in a cloud computing environment. In various implementations, method 300 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some implementations, method 300 is performed at least by cloud computing environment 100, as described in FIG. 1.

At 310 of method 300, the physical resources in a cloud computing environment are searched by a user, wherein the user is an entity other than a provider of the cloud computing environment. For example, a VAR searches for desired physical resources 112 (e.g., a desired server rack, number and/or type of CPU, storage resources such as computer memory of a specified size, networking capabilities, interconnects, etc.) in cloud 101 which is provided by an original cloud provider.

At 320, access to the physical resources is acquired by the user. For example, the VAR reserves or acquires access to physical resources 112 from the cloud provider via cloud control point 120 for a predetermined amount of time (e.g., one year).

In one implementation, at 322, access to a partition of the physical resources is acquired. For example, the VAR reserves cloud partition 110 that includes a plurality of physical computing machines.

In another implementation, at 324, access to the physical resources is acquired, by a reseller, from a provider of the cloud. For example, a VAR reserves physical resources 112 in cloud 101 from an original cloud provider.

In a further implementation, at 326, access to the physical resources, by an end-user, from the reseller is acquired. For example, an end-user pays a VAR for use of physical resources for a time period of a week.

At 330, the physical resources in the virtualized computing environment are accessed (e.g., the ability to control and/or manage the physical resources is granted). For example, a VAR controls and manages physical resources 112. In particular, the VAR controls and manages physical resources 112 upon reservation of the physical resources from the original cloud provider.

In one implementation, at 332, physical machines are controlled. For example, a rack of servers with desired CPU speed and memory is controlled.

In one implementation, at 340, an SLA between the reseller and an end-user is enabled. For example, an SLA exists between the VAR and the original cloud provider. Accordingly, if a server does not function properly and the SLA is not met, then the original cloud provider may be required to pay penalties to the VAR.

In another implementation, at 350, a cloud interface is implemented by a reseller. For example, the VAR implements and utilizes cloud user interface 130 for management and control of physical resources 112.

In a further implementation, at 360, a cloud control point is implemented by a reseller. For example, the VAR implements and utilizes cloud control point 120 to “see through” cloud 101 such that VAR is able to control and manage physical resources 112.

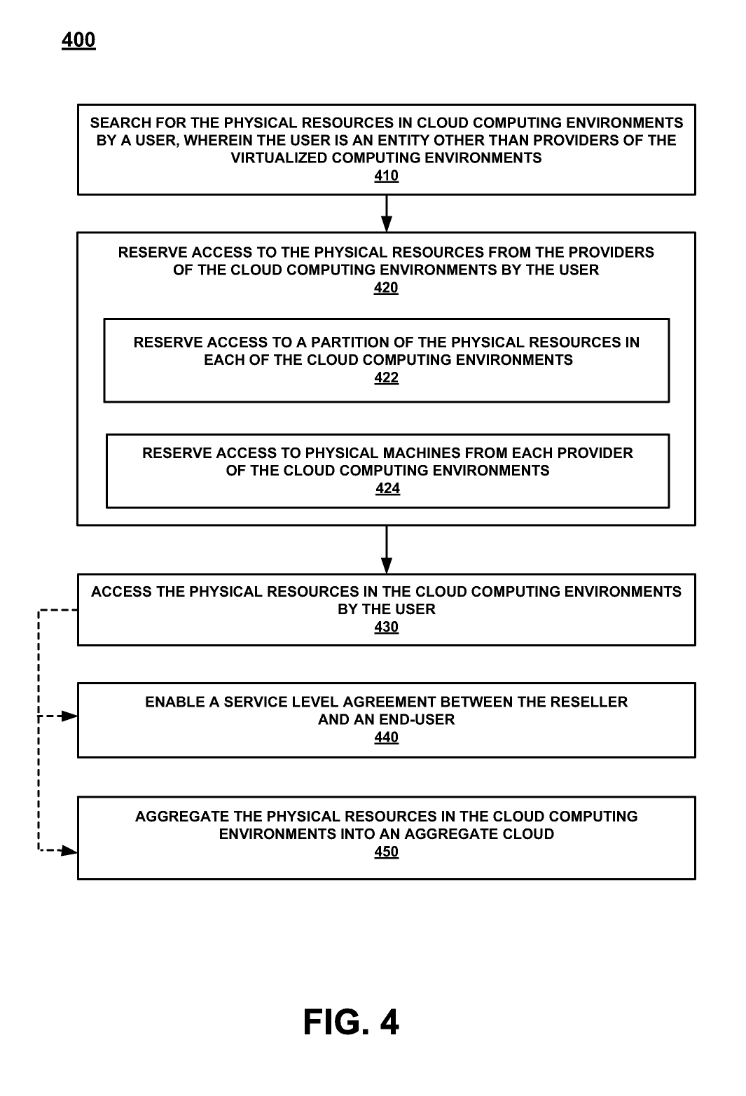

FIG. 4 depicts an implementation of a method 400 for accessing physical resources in a cloud computing environment. In various implementations, method 400 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some implementations, method 400 is performed at least by cloud computing environment 200, as described in FIG. 2.

At 410, physical resources are searched for in the cloud computing environments, wherein a user is an entity other than providers of the cloud computing environments. For example, a VAR searches for physical computing machines with a desired topology, resources and/or colocation in a plurality of disparate clouds 201-203. In one implementation, the original providers for each of the clouds are different.

At 420, access to the physical resources is reserved from the providers of the cloud computing environments. For example, a VAR reserves the desired resources (e.g., physical resources 212, 222 and 232) for one year.

In one implementation, at 422, access to a partition of the physical resources is reserved in each of the cloud computing environments. For example, cloud partitions 210, 220 and 230 are reserved such that a user can control and manage physical resources 212, 222 and 232, respectively.

In another implementation, at 424, access to physical machines from each provider of the cloud computing environments is reserved. For example, different server racks in each cloud are reserved.

At 430, the physical resources in the plurality of clouds are controlled. For example, a VAR is able to control physical resources 212, 222, and 232.

At 440, an SLA between the reseller and an end-user is enabled. For example, an SLA exists between the VAR and the original cloud provider. Accordingly, if a server does not function properly and the SLA is not met, then the original cloud provider may be required to pay penalties to the VAR.

At 450, the physical resources in the cloud computing environments are aggregated into an aggregate cloud computing environment. For example, physical resources 212, 222 and 232 are aggregated into aggregated cloud 204 by the VAR.

It should be appreciated that cloud computing environments 100-200 may provide improved features over other cloud computing environments including, but not limited to:

Increase QoS by dynamically changing services offered (e.g. different VMs, different underlying IaaS tools, etc).

Integrate service offerings by federating pieces of disparate clouds.

Transform cloud(s) to obtain the desired property by modulating the controls.

Identify the physical location (data center, rack, enclosure) of the VM/Data/Computation.

Higher utilization due to enabling upfront reservation and better ability to consolidate resources.

Collect analytics from physical resources to manage resource usage more effectively.

Ability to get access to new architectural features that may not be supported on other cloud environments (e.g. new networking tools, memory models, new GPU processors, etc).

VARs may enhance customers' value chain through access to disparate clouds, increase the customer business continuity, and drive the cost down.

VARs may be a point of convergence for consumers, partners, and providers. A CCP also may be a natural starting point for building hybrid-clouds (internal, plus external, plus Cloud of different degrees of trust).

A CCP may operate as a point that increases portability across different cloud-based solutions, and a point to test interoperability by large enterprises, including Government before committing into a cloud strategy.

Additionally or alternatively, a CCP may operate as an interface thru which users are given substantial autonomy to carry out experiments in their domain with a range of access rights for infrastructure, applications and services. In some implementations, such access rights may be dictated by policy rather than technology.

Furthermore, a CCP may effectively morph a cloud-partition such that applications and services residing in one cloud can interoperate across heterogeneous clouds.

In some fields of industry, industry-specific regulatory compliance may dictate certain requirements with respect to security, performance and governance issues. In such cases, a CCP may provide a mechanism that enables end users to test whether cloud computing environments provided by different cloud service providers can meet these kinds of regulatory requirements.

Various implementations are thus described. While particular implementations are described, it should be appreciated that the present technology should not be construed as limited by such implementations, but rather construed according to the following claims.

1. A method for accessing physical resources in a cloud computing environment, said method comprising:
searching for said physical resources in said cloud computing environment by a user, wherein said user is an entity other than a provider of said cloud computing environment;
acquiring access to said physical resources by said user from the provider of the cloud computing environment; and
accessing said physical resources in said cloud computing environment by said user.

2. The method of claim 1, wherein said acquiring access to said physical resources further comprises:
acquiring access to a partition of said physical resources.

3. The method of claim 1, wherein said acquiring access to said physical resources, further comprises:
acquiring access to said physical resources, by a reseller, from said provider.

4. The method of claim 3, further comprising:
acquiring access to said physical resources, by an end-user, from said reseller.

5. The method of claim 3, further comprising:
enabling a Service Level Agreement between said reseller and an end- user.

6. The method of claim 1, further comprising:
implementing a cloud interface, by a reseller.

7. The method of claim 1, further comprising:
implementing a cloud control point, by a reseller.

8. The method of claim 1, wherein said accessing said physical resources further comprises:
controlling physical machines.

9. A method for accessing physical resources in cloud computing environments, said method comprising:
searching for said physical resources in said cloud computing environments by a user, wherein said user is an entity other than providers of said cloud computing environments;
reserving access to said physical resources from said providers of said cloud computing environments, by said user; and
accessing said physical resources in said cloud computing environments by said user.

10. The method of claim 9, wherein said reserving access to said physical resources further comprises:
reserving access to a partition of said physical resources in each of said cloud computing environments.

11. The method of claim 9, wherein said reserving access to said physical resources further comprises:
reserving access to physical machines from each provider of said cloud computing environments.

12. The method of claim 9, further comprising:
aggregating said physical resources in said cloud computing environments into an aggregated cloud computing environment.

13. The method of claim 12, wherein said aggregating said physical resources further comprises:
aggregating said physical resources in said cloud computing environments into an aggregate cloud computing environment by a reseller.

14. The method of claim 13, further comprising:
enabling a Service Level Agreement between said reseller and an end- user.

15. A system for controlling physical resources in a cloud computing environment comprising:
a reseller cloud control point to allow a user to access physical resources in a cloud computing environment provided by a provider of said cloud computing environment, said cloud computing environment comprising a partition of physical resources; and
a reseller cloud interface to provide an interface between said physical resources in said cloud computing environment and said user.
